(19) United States
(12) Patent Application Publication
(10) Pub. No.: US 2020/0149344 A1
(43) Pub. Date: May 14, 2020

(54) Drop-Down Seal

(71) Applicant: Planet GDZ AG, Tagelswangen (CH)

(72) Inventor: Andreas Dintheer, Illnau (CH)

(21) Appl. No.: 16/631,609

(22) PCT Filed: Jun. 29, 2018
(86) PCT No.: PCT/EP2018/067669

§ 371 Date: Jan. 16, 2020

(30) Foreign Application Priority Data
Jul. 18, 2017 (EP) 17181903.0

(51) Int. Cl. E06B 7/215

(52) U.S. Cl. CPC E06B 7/215

(57) ABSTRACT

A sealing device for a door has a housing rail, a sealing strip which is held in the housing rail, with a carrier rail and with a sealing profile, and a drop-down mechanism for raising and lowering the sealing strip. The drop-down mechanism is fastened to the housing rail in a first fastening point and to the carrier rail in a second fastening point. The second fastening point allows a displacement of the sealing strip in the longitudinal direction of the sealing device and relative to the housing rail. This allows simple adaption to door situations in situ, with it being possible particular for the drop-down seal to be shortened to a desired length without the carrier rail then protruding too far.

### TECHNICAL SCOPE

The present invention relates to a drop-down seal for a door, in particular to a mechanically lowerable sealing device.

### PRIOR ART

Mechanically lowerable sealing devices that are automatic are known. They are generally used for doors without thresholds in order to seal the lower gap between the door leaf and the floor against draft, noise and light transmission. A seal, such as is disclosed, for example, in EP 0 338 974, has proven its worth.

The actuation of the sealing device is effected automatically on one or two sides when the door is closed and opened, by a spring-loaded release bolt, which protrudes from the door leaf, being pushed in when the door is closed. A sealing strip is lowered as a result by means of a lowering mechanism. When the door leaf is opened, the release bolt is re-released and the lowering mechanism raises the sealing strip again thanks to the resetting force of the springs.

Examples of corresponding lowering mechanisms are disclosed in EP 0 509 961, DE 3 526 720, DE 3 418 438 and DE 3 427 938.

A particularly suitable lowering mechanism is described in DE 19 516 530. It includes the mentioned release bolt, to which a flat slide is fastened. The slide is held displaceably inside the housing rail. The lowering mechanism additionally includes at least two leaf springs which are fixedly connected to the slide at one first end each and are fastened pivotably to the housing rail at one second end each. In the central region the leaf springs are connected in a hinged manner to the sealing strip each by means of a plastics material body. A transverse bore, which is pushed through by a journal, is present for this purpose for a first leaf spring. Elongated holes, which are each also pushed through by a journal, are present for the second and following leaf springs. The transverse bore enables the sealing strip to be fixed to the leaf spring. The elongated holes allow the leaf springs to be deflected in a variable manner so that the sealing strip is automatically adapted to the inclination of the building floor.

In addition, sealing devices which can be shortened are known. EP 2 050 918 discloses a lowering mechanism which is set back at both ends of the sealing device in such a manner that the housing rail, the carrier rail and also the seal profile of the sealing device can be shortened together.

DE 20 2011 051 326 U describes a sealing device with multiple portions, wherein it is able to be shortened by the corresponding portion length.

The described spring-loaded lowering mechanisms have proven their worth in practice. It is characteristic that they displace the sealing strip in the longitudinal direction of the sealing device during lowering. This has to be taken into consideration when assembling the sealing device so that the hard carrier rail of the sealing strip does not grind on the door frame and scratch said door frame or so that the elastomer seal profile does not bend too much in the vertical door gap. If the sealing device, however, is chosen to be too short or the distance from the door frame is set to be too large, the sealing action is not optimum as the soft seal profile no longer abuts against the door frame and consequently can no longer seal the entire gap between the door leaf and the building floor. The known seals are, however, correspondingly optimized. If, however, the drop-down seal has to be shortened in order to be adapted to the weight of the door leaf, said optimum adaptation is lost.

FIGS. 1a to 1d show a detail of a drop-down seal according to the prior art. It is supplied from the factory as shown in FIG. 1a.

The drop-down seal comprises a housing rail 1 as well as a sealing strip which is held therein so as to be raisable and lowerable. The sealing strip includes a carrier rail 2 and a seal profile 3 which is fastened thereto. The end face situated opposite the release button of the drop-down seal is visible. In the raised state the carrier rail 2 is set back on said end face with respect to the housing rail 1. The seal profile 3 protrudes from the carrier rail 2. The seal profile 3 is usually aligned with the housing rail 3 on said end face. The arrangement is usually different on the opposite end face that is not shown. There the carrier rail 2 is usually aligned with the end face of the housing rail 1 and the seal profile 3 protrudes from the housing rail 1.

When being lowered, the sealing strip is displaced in the longitudinal direction L, as shown in FIG. 1b.

Such drop-down seals are often shortened, as mentioned above, in situ or in the door factory in order to be adapted to the weight of the door to be sealed. To this end, the drop-down seal, i.e. the housing rail 1, the carrier rail 2 and the seal profile 3, can be shortened together by the end piece opposite the release button being sawn off or separated off in another manner. The shortening line K is shown by the dotted line in FIG. 1b. It can also be situated at a different position.

FIG. 1c shows the drop-down seal in the shortened state. Housing rail 1, carrier rail 2 and seal profile 3 are aligned with one another on the end face opposite the release button. If said shortened seal is then lowered, as is shown in FIG. 1d, not only the seal profile 3 but also the carrier rail 2 protrudes from the housing profile 1. Depending on the situation on site, the carrier rail 2 now scrapes the door frame or it forms an unwanted gap between the seal profile 3 and the door frame. Neither is desired.

### REPRESENTATION OF THE INVENTION

It is, consequently, an object of the invention to create a sealing device which can be used in an optimum manner even once it has been shortened.

Said object is achieved by a sealing device with the features of claim 1.

The sealing device according to the invention for a door comprises a housing rail, a sealing strip which is held in the housing rail and a lowering mechanism for raising and lowering the sealing strip relative to the housing rail and transversely to the longitudinal direction of the sealing device. According to the invention, the sealing strip in the raised state is displaceable from a starting position into another position in the longitudinal direction of the sealing device and relative to the housing rail. It can preferably be displaced manually. It can preferably be pulled or pushed into said position. The sealing strip is preferably also resettable into the starting position again.

The terms “displace”, “displaceability” and similar are used below. In each case this means a movement from one position into another which does not necessarily have to be effected by pushing but could also be achieved as a result of another type of force application.

The drop-down seal can consequently be worked on in said shifted position. In particular, the housing rail can be shortened together with the sealing strip and the sealing strip then brought back again into its starting position. This ensures that the sealing strip does not protrude or hardly protrudes in the lowered state even in the case of a shortened drop-down seal and consequently cannot scrape along the door frame when being lowered and raised.

The sealing strip is preferably displaceable in its position approximately or precisely by a distance by which it is also displaced typically in the longitudinal direction when being lowered. This ensures that the shortened drop-down seal still comprises the same optimized characteristics as a non-shortened seal from the factory.

The sealing strip is preferably connected to the lowering mechanism by means of a fastening module, wherein the fastening module is fixedly connected to the lowering mechanism and wherein the location or position of the sealing strip is modifiable in the longitudinal direction with reference to the fastening module. The arrangement can also be reversed, i.e. the sealing strip is fixedly connected to the fastening module and the position of the fastening module is modifiable in the longitudinal direction with reference to the lowering mechanism.

The fastening module is preferably produced from plastics material. It is preferably held between two side walls of the sealing strip and preferably fixes a leaf spring of the lowering mechanism.

In preferred exemplary embodiments, the sealing strip comprises a carrier rail and a seal profile arranged thereon. The seal profile preferably consists of a soft elastic material, in particular an elastomer. The housing rail and the carrier rail are preferably produced from a metal, in particular aluminum.

In preferred embodiments, the lowering mechanism is fastened to the housing rail in a first fastening position and to the carrier rail in a second fastening position. The second fastening position enables the sealing strip to be shifted, also called displaced, in the longitudinal direction of the sealing device and relative to the housing rail.

The sealing strip, in particular the carrier rail, is preferably displaceable in at least one discrete step and is held sturdily in the new position so that the sealing strip is not able to be displaced on its own during the shortening operation and also during use.

Precisely one displacement position is preferably present. However, multiple displacement positions can also be present. The starting position of the sealing strip, in this case, can be located in the center or at an end of the displacement range.

The second fastening position preferably enables the sealing strip or the carrier rail to be displaced relative to the lowering mechanism. The entire sealing strip, i.e. the carrier rail and the seal profile, is preferably displaced.

The seal profile or at least part thereof is preferably held at the carrier rail so as to be displaceable in the longitudinal direction so that it is able to be moved back into an end-face position protruding from the carrier rail once it has been shortened. In other embodiments, the seal profile can be lengthened. This can be achieved in preferred embodiments by manually “massaging” the material of the seal profile in the longitudinal direction.

In a preferred embodiment, the second fastening position is formed by a connection between at least one journal and at least one displacement opening. The at least one journal engages in the at least one displacement opening and is held in said displacement opening. The at least one displacement opening is realized in a larger manner than the journal in the longitudinal direction of the sealing device so that the position of the at least one journal inside the displacement opening is modifiable in the longitudinal direction of the sealing device. Said device can be produced in a cost-efficient manner and is simple to assemble.

The at least one journal is preferably connected fixedly to the lowering mechanism and the at least one displacement opening is arranged in the carrier profile. However, the reversed arrangement is also possible.

So that discrete positionings are possible or so that the carrier rail is not able to move on its own when the drop-down seal is used as intended and also when the seal is shortened, the displacement opening, when viewed in the longitudinal direction, comprises in its central region a tapering which can be overcome by the journal under increased force. If more than two displacement positions of the carrier rail are to be possible, the displacement opening can be realized with multiple taperings or chicanes which are arranged one behind another in the longitudinal direction.

In preferred embodiments, the lowering mechanism comprises at least one leaf spring which extends in the longitudinal direction of the sealing device inside the housing rail and which is connected to the housing rail at the first fastening position so as to be pivotable, to the carrier rail at the second fastening position in a hinged manner and to an actuating element, preferably a slide, at a third fastening position in a fixed manner. The at least one leaf spring is preferably connected fixedly to the fastening module.

At least two such leaf springs are preferably arranged one behind the other and each is fastened with its own fastening points, wherein each of the second fastening points enables the displacement of the entire carrier rail.

A lowering mechanism, as is described and shown in DE 19 516 530 and EP 2 050 918 which are mentioned in the introduction, is preferably used.

The fastening module is preferably arranged between two side walls of the carrier rail and comprises two journals, wherein one of the two journals is directed toward a side wall and wherein each of the two side walls comprises one of the at least one displacement opening.

Said fastening module can be produced in a cost-efficient manner and is simple to assemble.

The fastening module preferably consists of plastics material so that it comprises lightly sprung characteristics which are helpful when assembling and disassembling. The fastening module can preferably be clipped into the housing rail.

The fastening module preferably comprises at least one upwardly projecting lug which projects above the carrier profile. Two oppositely situated lugs are preferably present. This also makes assembly easier.

The idea according to the invention is suitable, in particular, for embodiments where the lowering mechanism, when lowering the sealing strip, displaces said sealing strip in the longitudinal direction relative to the housing rail. However, it can also be used in other sealing devices.

Further embodiments are specified in the dependent claims.

### BRIEF DESCRIPTION OF THE DRAWINGS

Preferred embodiments of the invention are described below by way of the drawings which serve purely for explanation and are not to be seen as limiting. The drawings are as follows:

FIG. 1a shows a perspective representation of part of a drop-down seal according to the prior art in the raised state as produced in the factory;

FIG. 1b shows the drop-down seal according to FIG. 1a in the lowered state prior to being shortened;

FIG. 1c shows the drop-down seal according to FIG. 1a in the raised state after being shortened;

FIG. 1d shows the shortened drop-down seal according to FIG. 1c in the lowered state;

FIG. 2a shows a perspective representation of part of a drop-down seal according to the invention;

FIG. 2b shows an enlarged detail of the drop-down seal according to FIG. 2a;

FIG. 3a shows a perspective representation of part of a drop-down seal according to FIG. 1a in the raised state as produced in the factory;

FIG. 3b shows the drop-down seal according to FIG. 3a with a displaced sealing strip;

FIG. 3c shows the drop-down seal according to FIG. 3b in the shortened state;

FIG. 3d shows the drop-down seal according to FIG. 3c with the sealing strip set back into its original horizontal position;

FIG. 3e shows the drop-down seal according to FIG. 3d in the lowered state;

FIG. 3f shows the drop-down seal according to FIG. 3e with the seal profile protruding from the front of the carrier profile;

FIG. 4 shows a perspective representation of a region of the drop-down seal without housing rail and sealing profile, in a first position of the carrier profile;

FIG. 5 shows an enlarged detail of the representation according to FIG. 4;

FIG. 6 shows a side view of the region according to FIG. 4 with a leaf spring only shown in part;

FIG. 7 shows a cross section along B-B according to FIG. 6 and along E-E according to FIG. 11;

FIG. 8 shows a longitudinal section along C-C according to FIG. 6;

FIG. 9 shows a perspective representation of a region of the drop-down seal without housing rail and seal profile, in a second position of the carrier profile;

FIG. 10 shows an enlarged detail of the representation according to FIG. 9;

FIG. 11 shows a side view of the region according to FIG. 9 with the leaf spring only shown in part and

FIG. 12 shows a longitudinal section along A-A according to FIG. 11.

### DESCRIPTION OF PREFERRED EMBODIMENTS

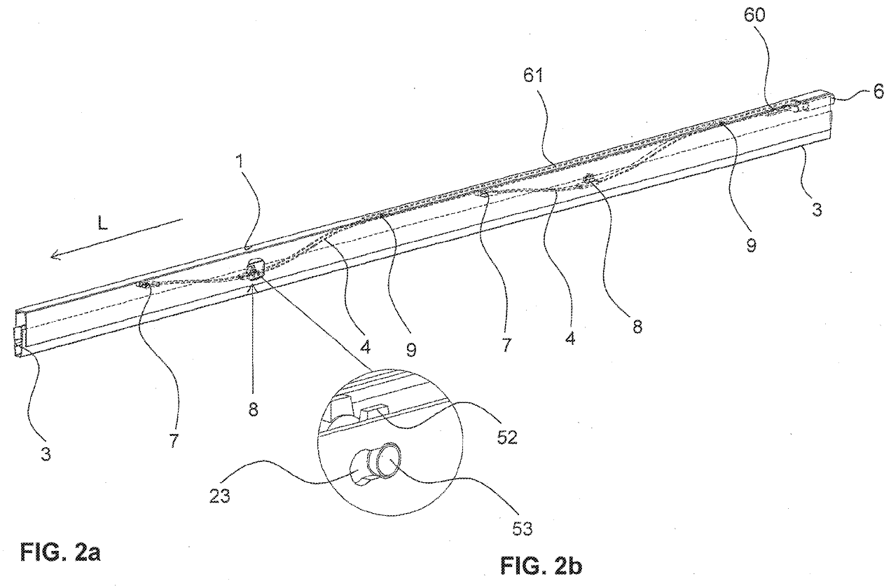

FIG. 2a shows a sealing device according to the invention, hereafter called a drop-down seal. Such drop-down seals are mounted in the lower region of a door leaf of a swing or sliding door.

For this purpose, they are either inserted into a lower groove of the door leaf, fastened to a lower end face or are arranged laterally in the lower region of the door leaf. Assemblies in the upper or lateral region of the door leaf are also possible. If terms such as “below” and “above” are used below, said locational and directional specifications refer to the use of the drop-down seal in the lower region of the door leaf. The terms are to be adapted in an analogous manner to the other mounting positions and the description and the patent claims should also include them.

The drop-down seal is automatically lowered mechanically when the door leaf is closed in order to protect a gap between the door leaf and the building floor against light transmission, draft and noise. Fire protection, smoke protection and flood protection are also possible depending on the design of the seal profile.

The drop-down seal according to the invention also comprises the housing rail 1 and the sealing strip which is raisable and lowerable therein. The sealing strip includes the carrier rail 2 and the seal profile 3 which is fastened thereto.

The housing rail 1 is preferably fastened to the door leaf on both sides by way of a fastening bracket. Other types of fastenings are disclosed in the prior art and are also applicable here.

The housing rail 1 and the carrier rail 2 are preferably produced from an extruded profile, in particular from aluminum. The seal profile 3 is preferably realized in one piece. It can also be realized in multiple pieces. The seal profile 3 preferably consists of silicone or rubber or from another elastomer material.

The drop-down seal additionally includes a lowering mechanism in order to lower the sealing strip automatically when the door leaf is closed. The lowering mechanism includes a release button 6 which protrudes from the housing rail 1 at a front end. It is connected via an actuating rod 60 to a flat slide 61. The actuating rod 60 and the slide 61 extend in the longitudinal direction L of the housing rail 1 and can be moved in said longitudinal direction relative to the housing rail 1.

The lowering mechanism additionally includes at least one, preferably two or more leaf springs 4 which are arranged one behind another in the longitudinal direction L of the drop-down seal.

Each leaf spring 4 is pivotably connected to the housing rail 1 at a first fastening position 7 by way of one of its ends. The central region of each leaf spring 4 is connected in a hinged manner to the carrier rail 2 at a second fastening position 8. The second end of each leaf spring 4 is connected fixedly to the slide 61 at a third fastening position 9. As an alternative to this, the first leaf spring 4 can also be connected directly to the actuating rod 60. The first fastening position 7 is preferably situated on the side of the leaf springs 4 which are remote from the release button 6.

The release button 6 is present on the door frame when the door leaf is closed and is pressed in. As a result, it displaces the slide 61 in the longitudinal direction L of the drop-down seal. The leaf springs 4 are bent and the carrier rail 2 is lowered together with the seal profile 3 which is fastened thereto. When the door leaf is opened, the release button 6 is released again, the leaf springs 4 are able to relax and the sealing strip is raised again as a result.

Said lowering mechanism and said type of fastening are known and have proven their worth. Alternative arrangements and realizations are disclosed in the prior art and can also be used analogously in the drop-down seal according to the invention.

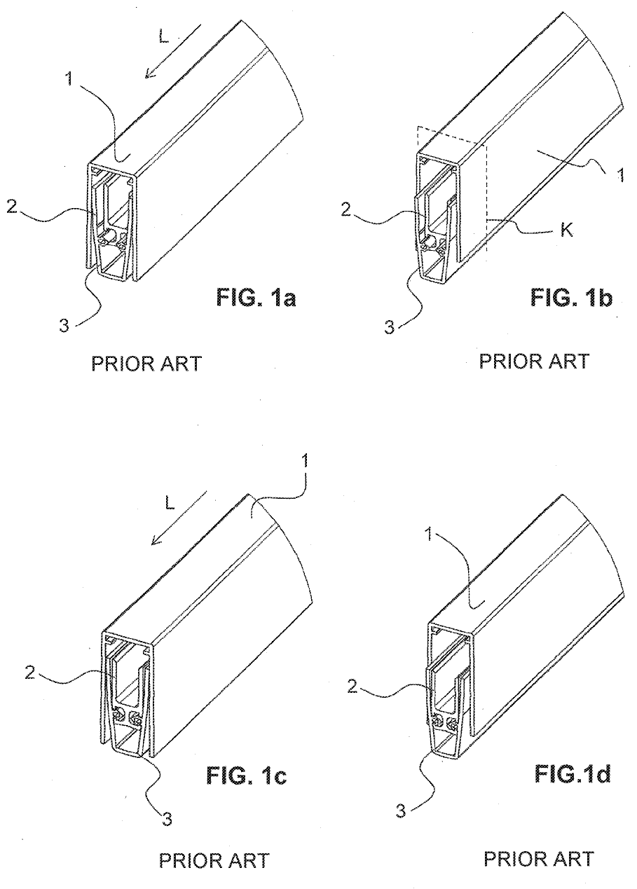

As already mentioned above, when the sealing strip is lowered said sealing strip is not only lowered but is also moved in the longitudinal direction L on one end side, namely the side remote from the release button 6. This is why, when the drop-down seal is manufactured, the carrier rail 2, in the raised starting state, is preferably arranged set back relative to the housing rail 1 on said side. The seal profile 3 is also arranged on said end face protruding from the carrier rail when the drop-down seal is manufactured. It preferably ends flush with the housing rail 1 and in an even more preferred manner it protrudes slightly from said housing rail. This is shown in FIG. 1a. This corresponds to the behavior of the seals according to the prior art, as explained in the introduction.

According to the invention, the sealing strip in the raised state is then displaceable in the longitudinal direction L of the drop-down seal. In the exemplary embodiment shown here, the second fastening point 8 is realized correspondingly for this purpose. This can be seen, for example, in FIGS. 2a and 2b. Said realization is described in detail further below in the text. In FIGS. 2a and 2b, the sealing strip is already arranged offset forward in a manner according to the invention, as can be seen, for example, by way of the position of the journal 53 in the displacement opening 23. The sealing strip is consequently already situated in the second position.

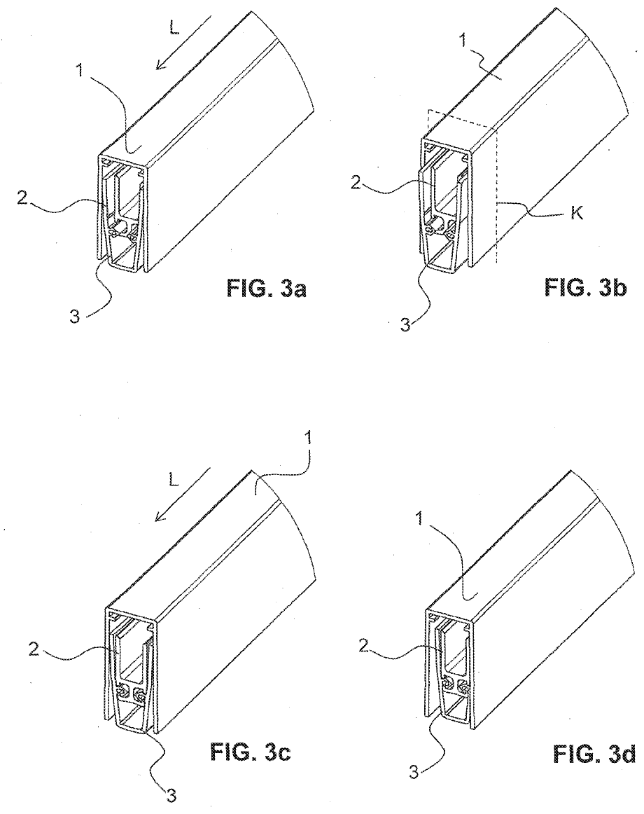

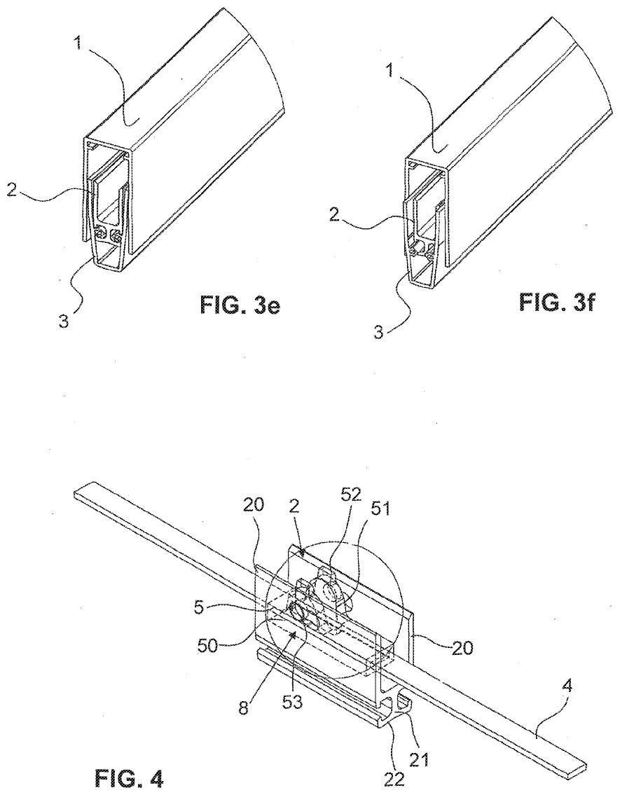

The seal according to the invention as produced at the factory can be seen in FIG. 3a. The relative arrangement of housing rail 1, carrier rail 2 and seal profile 3 is no different to that according to FIG. 1a. In FIG. 3b the sealing strip is displaced according to the invention in the longitudinal direction L toward the free end of the housing rail 1. In said state, the entire seal can be shortened again by the housing rail 1, the carrier rail 2 and the seal profile 3 being shortened, in particular sawn through, together. One of the possible shortening lines is shown in FIG. 3b and is provided with the reference symbol K. The shortened seal is shown in FIG. 3c. There is no difference here either in the end-face appearance of said shortened seal compared to that of the seal according to FIG. 1c.

The sealing strip of the seal according to the invention can then be moved back, however, into its original position again with reference to the housing rail 1. This is shown in FIG. 3d. In the lowered state, as shown in FIG. 3e, the carrier rail 2, which has been set back again, and consequently the housing rail 1 still do not protrude. However, so that the seal profile 3 is able to reduce the vertical gap between the door frame and housing rail, the front end of the seal profile 3 can now be pushed forward. The result is shown in FIG. 3f. Once again, the seal according to 3f comprises the same appearance or at least a similar appearance at the front as the drop-down seal according to FIG. 3a which is original as supplied from the factory. It has been shortened, however, to a desired length compared to said drop-down seal in FIG. 3a.

Pulling out the end-face end of the seal profile 3 can be made easier in different ways. In simple embodiments, the seal profile 3 is displaced over its entire length relative to the carrier rail 2. In other embodiments, the seal profile 3 comprises a bellows-shaped region which is pulled apart in order to allow the free end to project out of the housing rail 1. In further embodiments, the seal profile 3 is massaged by hand in such a manner and at the same time pulled in the longitudinal direction L that the material stretches and the overall length of the seal profile 3 is thus increased, as a result of which the free end is also able to be pulled out of the housing rail 1.

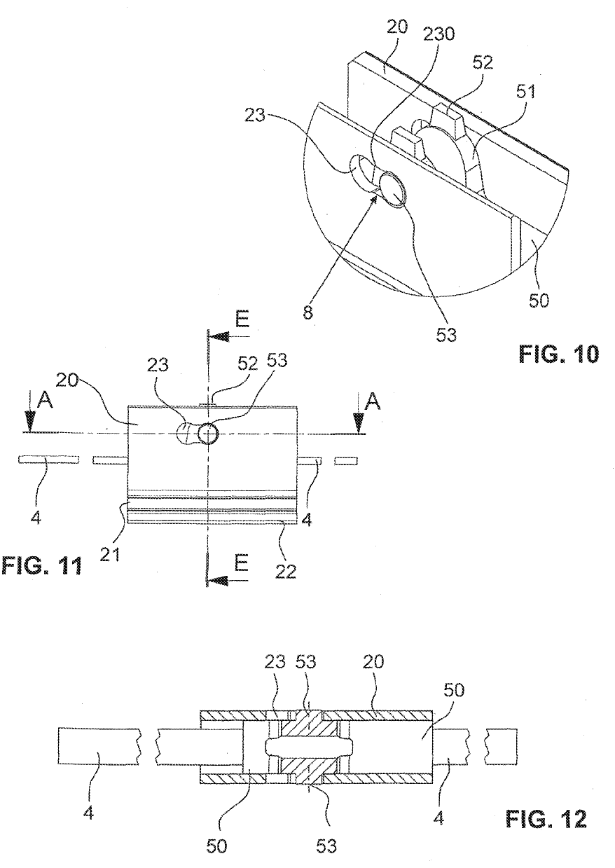

FIGS. 4 to 13 show the elements of the drop-down seal according to the invention which enable, for example, the above-described adjustability of the sealing strip and the ability of the seal profile 3 to be shortened when the drop-down seal is in the already assembled state.

FIG. 4 shows a short portion of the carrier rail 2 in the region of the second fastening position 8. If the drop-down seal comprises multiple leaf springs 4 and consequently multiple second fastening positions 8, the other second fastening positions 8 are preferably realized in an identical manner. In any event, they also enable the displaceability of the sealing strip described below.

The carrier rail 2 is upwardly open, realized in a u-shaped manner in cross section with two side walls 20 which are arranged spaced apart from one another. The closure is formed by a downwardly projecting, T-shaped carrier part with a connecting web 21 and a carrier bar 22. The seal profile, not shown in said FIG. 4, is held at the T-shaped carrier part. The T-shaped carrier part forms, for this purpose, two laterally open receiving means for receiving correspondingly formed retaining ribs of the seal profile 3. The seal profile 3 is held at the carrier profile 2. It can be displaced, for example, in the longitudinal direction relative to the carrier profile 2 as a result of manual “massaging”.

A fastening module 5 is arranged in the cavity between the two side walls 20. Said fastening module preferably consists of plastics material. It comprises a cuboid, flat basic body 50 which is penetrated by one of the leaf springs 4. The leaf spring 4 is connected fixedly to the basic body 50 and cannot be displaced relative to said basic body.

Side walls 51, which are spaced apart from one another, are present, preferably integrally molded, on the basic body 50. They extend parallel to the side walls 20 of the carrier rail 2.

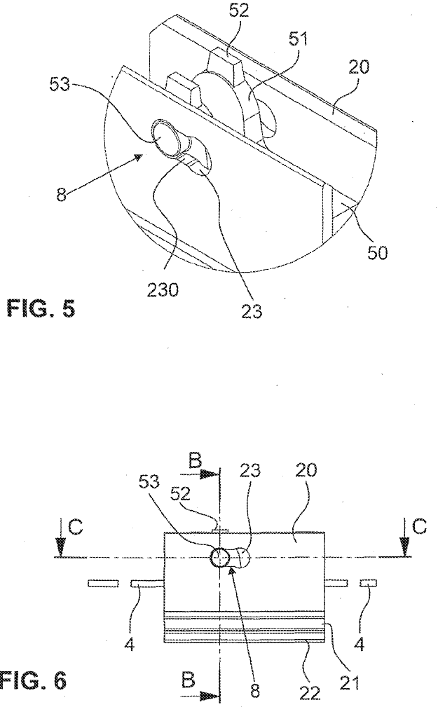

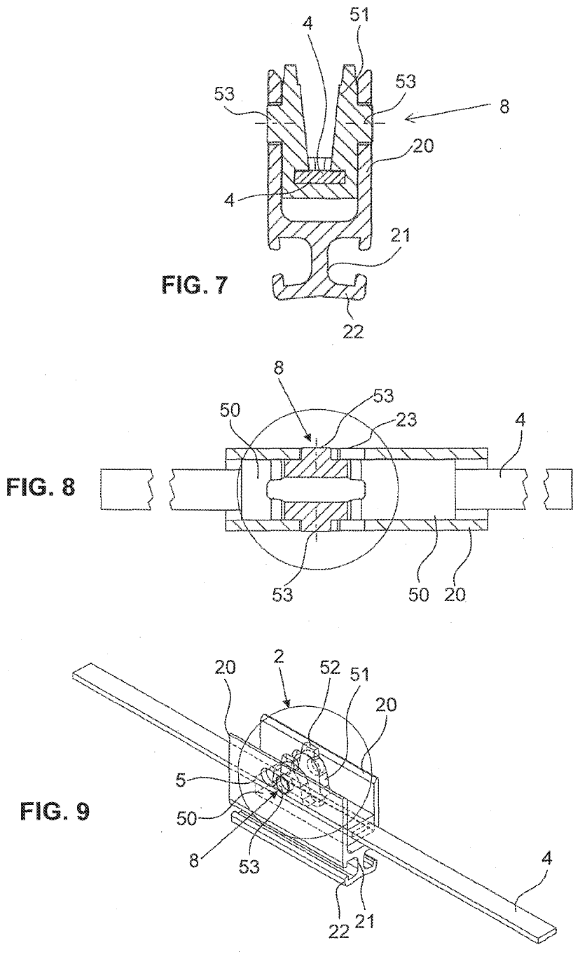

The upper end of each side wall 51 is realized by an upwardly protruding lug 52, which preferably projects above the carrier rail 2, as can be seen well in FIG. 5. A journal 53, which is preferably also realized in one piece with the rest of the fastening module 5, protrudes outwardly on each side wall 51 of the fastening module 5. This can be seen well in FIGS. 7 and 8.

Each side wall 20 of the carrier rail 2 comprises a displacement opening 23 which is realized in the form of an elongated hole which extends in the longitudinal direction. The elongated hole is preferably realized as a figure of eight with a central tapering. One of the two journals 53 engages in said displacement opening 23.

The upwardly protruding lugs 52 make it easier to assemble the fastening module 5 in the carrier rail 2. The fastening module 5 is preferably pressed into said carrier rail.

The displacement openings 23 allow the carrier rail 2 and consequently the sealing strip to be displaced relative to the fastening module 5 and consequently to the leaf springs 4 and the housing rail 1.

The displacement opening 23 is preferably realized with one or multiple taperings 230 so that the journals 53 are able to latch into individual displacement positions. Two displacement positions and one tapering 230, which is arranged centrally in the longitudinal direction, are present in said exemplary embodiment, as can be seen well in FIGS. 5 and 6.

In FIGS. 4 to 8 the carrier rail 2 is situated in a first position with reference to the housing. The journals 53 are latched in a first position inside the displacement opening 23.

In FIGS. 9 to 12 the carrier rail 2 has been displaced and the journals 53 are situated in a second position inside the displacement opening 23, as can be seen well by comparing the corresponding FIGS. 4 to 8.

If the release button 6 is situated on the right-hand side of the seal according to FIGS. 4 and 9, the first position is thus the starting position. If the carrier rail 2 is lowered, the seal profile 3 thus protrudes above the housing rail 1 laterally, as can be seen in FIG. 2a. In order to shorten the seal profile 3, the carrier rail 2 can then be pushed into the second position by pressure at the end face or by tension on the sealing strip. Said pressure or tension is preferably effected manually.

The length of the displacement opening 23 preferably corresponds at least approximately to the displacement of the sealing strip in the longitudinal direction when the sealing strip is lowered.

The drop-down seal can then be cut off using simple tools and consequently shortened to a desired measurement.

Said displaceability of the sealing strip in the longitudinal direction of the drop-down seal enables simple adaptation to door situations on site and at the door factory without the method of operation of the seal being diminished and in particular without the relative end-face arrangement of housing rail 1, carrier rail 2 and seal profile 3 being negatively impaired. In particular, the carrier rail 2 still does not protrude too far forward after shortening.

LIST OF REFERENCES

| | |
|---|---|
| 1 | Housing rail |
| 2 | Carrier rail |
| 20 | Side wall |
| 21 | Connecting web |
| 22 | Lower carrier bar |
| 23 | Displacement opening |
| 230 | Tapering |
| 3 | Seal profile |
| 4 | Leaf spring |
| 5 | Fastening module |
| 50 | Basic body |
| 51 | Side wall |
| 52 | Lug |
| 53 | Journal |
| 6 | Release button |
| 60 | Actuating rod |
| 61 | Slide |
| 7 | First fastening position |
| 8 | Second fastening position |
| 9 | Third fastening position |
| L | Longitudinal direction |
| K | Shortening line |

1. A sealing device for a door, the sealing device comprising:
a housing rail;
a sealing strip which is held in the housing rail; and
a lowering mechanism for raising and lowering the sealing strip relative to the housing rail and transversely to a longitudinal direction of the scaling device,
wherein the sealing strip in a raised state is displaceable from a starting position into another position in the longitudinal direction of the scaling device and relative to the housing rail.

2. The scaling device as claimed in claim 1, wherein the scaling strip is manually displaceable in the longitudinal direction into the another position relative to the housing rail.

3. The scaling device as claimed in claim 1, wherein the starting position and the another position are at a distance from one another which corresponds at least approximately to a displacement path of the scaling strip which is measured in the longitudinal direction when the scaling strip is lowered.

4. The scaling device as claimed in claim 1, wherein the sealing strip is connected to the lowering mechanism by means of a fastening module, wherein
a) the fastening module is fixedly connected to the lowering mechanism and wherein a position of the scaling strip is modifiable in the longitudinal direction with reference to the fastening module, or
b) a position of the fastening module is modifiable in the longitudinal direction with reference to the lowering mechanism and wherein the scaling strip is connected fixedly to the fastening module.

5. The scaling device as claimed in claim 1, wherein the scaling strip comprises a carrier rail and a seal profile arranged thereon, wherein the carrier rail is displaceable in a longitudinal position thereof.

6. The scaling device as claimed in claim 1, wherein the sealing strip is displaceable in at least one discrete step.

7. The scaling device as claimed in claim 5, wherein the lowering mechanism is fastened to the housing rail in a first fastening position and to the carrier rail in a second fastening position, and wherein the second fastening position enables the sealing strip to be displaced in the longitudinal direction of the sealing device and relative to the housing rail.

8. The sealing device as claimed in claim 7, wherein the second fastening position enables the carrier rail to be displaced relative to the lowering mechanism.

9. The scaling device as claimed in claim 7, wherein the second fastening position is formed by a connection between at least one journal and at least one displacement opening, wherein the at least one journal engages in the at least one displacement opening and is held in said displacement opening, and wherein the at least one displacement opening is realized in a larger manner than the at least one journal in the longitudinal direction of the scaling device so that the position of the at least one journal inside the displacement opening is modifiable in the longitudinal direction of the scaling device.

10. The sealing device as claimed in claim 9, wherein the at least one journal is connected fixedly to the lowering mechanism and the at least one displacement opening is arranged in the carrier profile.

11. The scaling device as claimed in claim 9, wherein the displacement opening, when viewed in the longitudinal direction, comprises in its central region a tapering which can be overcome by the journal under increased force.

12. The scaling device as claimed in claim 7, wherein the lowering mechanism comprises at least one leaf spring which extends in the longitudinal direction of the sealing device inside the housing rail and which is connected to the housing rail at the first fastening position so as to be pivotable, to the carrier rail at the second fastening position in a hinged manner and to an actuating element at a third fastening position in a fixed manner.

13. The scaling device as claimed in claim 11, wherein at least one leaf spring is connected fixedly to a fastening module.

14. The sealing device as claimed in claim 11, wherein there are present at least two leaf springs which are each fastened at the named first, second and third fastening points, wherein each of the second fastening points enable the carrier rail to be displaced.

15. The scaling device as claimed in claim 11, wherein the fastening module is arranged between two side walls of the carrier rail and comprises two journals, wherein one of the two journals is directed toward a side wall and wherein each of the two side walls comprises one of the at least one displacement opening.
